(19) United States
(12) Patent Application Publication
(10) Pub. No.: US 2026/0186206 A1
(43) Pub. Date: Jul. 2, 2026

(54) ION-DOPED OPTICAL WAVEGUIDE STRUCTURE, USE METHOD THEREOF AND ION-DOPED OPTICAL WAVEGUIDE ARRAY

(71) Applicant: SILITH TECHNOLOGY PTE. LTD., SINGAPORE (SG)

(72) Inventors: Xingyu ZHANG, Shanghai (CN); Ke ZHANG, Shanghai (CN)

(73) Assignee: SILITH TECHNOLOGY PTE. LTD., SINGAPORE (SG)

(21) Appl. No.: 19/548,876

(22) Filed: Feb. 24, 2026

Related U.S. Application Data
(63) Continuation of application No. PCT/CN2023/115525, filed on Aug. 29, 2023.

(51) Int. Cl. G02B 6/134; G02B 6/122; G02B 6/12

(52) U.S. Cl. CPC G02B 6/134; G02B 6/122; G02B 2006/12142

(57) ABSTRACT

An ion-doped optical waveguide structure and a use method thereof, and an ion-doped optical waveguide array are provided. The ion-doped optical waveguide structure comprises an optical waveguide; the doped region comprises a P-type doped region and an N-type doped region which are arranged on the two sides of the optical waveguide respectively, and the P-type doped region and the N-type doped region are isolated from each other; the electrodes are arranged on the P-type doped regions and the N-type doped regions; the electric signal adjusting circuit comprises a plurality of electric input ends and at least one electric output end, the electric input ends and the electric output ends are connected to the corresponding electrodes respectively, and the electric signal adjusting circuit is used for adjusting the magnitude of electric signals applied to the electrodes.

### CROSS-REFERENCE TO RELATED APPLICATION

This application is a continuation of international application of PCT application serial no. PCT/CN2023/115525, filed on August 29, 2023. The entirety of the above-mentioned patent application is hereby incorporated by reference herein and made a part of this specification.

### FIELD OF THE APPLICATION

The present disclosure relates to the technical field of photonic integration, and in particular to an ion-doped optical waveguide structure, a use method thereof, and an ion-doped optical waveguide array.

### BACKGROUND

In a photonic integrated circuit (a photonic chip), by doping a plurality of ions into a plurality of optical waveguides made of a plurality of semiconductor materials, and applying a plurality of electrical signals, a plurality of optical properties including phase of an optical wave and intensity, and more, can be adjusted and controlled, further realizing optical signal processing. In an embodiment, in a silicon photonic chip, by doping a plurality of ions into the optical waveguides, a plurality of active devices will be prepared, including an optical phase shifter, a variable optical attenuator (VOA) and more.

FIG. 1 illustrates a schematic diagram on an optical phase shifter in the prior art. Both side regions of the optical waveguide comprise a same type of ion (P-type or N-type) doping, thus having a resistance characteristic. Both A and B in FIG. 1 are electrode regions, comprising specifically one or more layers of conductive metals, via holes, ohmic contacts, and more (not shown in detail in the figure), configured to induce an external electrical signal to an ion-doped region. Note: an optical waveguide cladding (such as a silicon dioxide cladding commonly used) is not shown in the figure. In a real implementation, a current can be generated by applying an electrical signal V1 and an electrical signal GND to both ends of each resistor, indicated as a plurality of arrows in FIG. 1, a current flowing direction is parallel to a direction of the optical waveguide. When the current flows through the doped region with a resistance, thermal energy is generated and conducted to the optical waveguide, further a refractive index of the optical waveguide is changed by a thermo-optic effect, thus a phase of the optical wave propagating in the optical waveguide is changed, that is, an optical phase shifter is achieved.

FIG. 2 illustrates a schematic diagram on a variable optical attenuator (VOA) in the prior art. Both left side region and right side region (a left direction and a right direction shown in FIG. 2) of the optical waveguide are P-type ion-doped and N-type ion-doped respectively, thus having a resistance characteristic. Both A and B in FIG. 2 are electrode regions, comprising specifically one or more layers of conductive metals, via holes, ohmic contacts, and more (not shown in detail in the figure), configured to induce an external electrical signal into the ion-doped region. In a real implementation, by applying an electrical signal V1 and an electrical signal GND to a P-type doped region and an N-type doped region respectively, a current will be generated between two doped regions, a flowing direction of the current is crossing (perpendicular to) a direction of the optical waveguide, indicated by a plurality of arrows in FIG. 2. When a plurality of carriers (electrons and holes) in the current are propagating in the optical waveguide, photon absorption will happen, further causing an intensity of an optical wave propagating in the optical waveguide get changed, thus a VOA is achieved.

In the photonic integrated circuits, usually both the optical phase shifter and the VOA are required. According to a plurality of application requirements, the optical phase shifter and the VOA may be applied sequentially or simultaneously. In a conventional practice, the optical phase shifter and the VOA are placed at different locations separately on the photonic integrated circuit as required. In a large-scale multi-channel photonic integrated circuit, a total number of the optical phase shifters and the VOAs will be huge, occupying a large amount of space in a chip, thus increasing a chip size and further increasing a cost.

Therefore, it is necessary to provide an ion-doped optical waveguide structure, a use method thereof, and an ion-doped optical waveguide array, to solve the problems mentioned above existing in the prior art.

### BRIEF SUMMARY OF THE APPLICATION

According to the defects in the prior art described above, the present disclosure provides an ion-doped optical waveguide structure, a use method thereof, and an ion-doped optical waveguide array.

In order to achieve the objective mentioned above, the technical solution of the present disclosure is as follows:

the present disclosure provides an ion-doped optical waveguide structure, comprising:

an optical waveguide;

a plurality of doped regions, comprising a P-type doped region and an N-type doped region arranged respectively on both sides of the optical waveguide, while the P-type doped region and the N-type doped region are isolated from each other;

a plurality of electrodes, the electrodes are arranged on the P-type doped region and the N-type doped region; and

an electrical signal adjusting circuit, comprising a plurality of electrical input terminals and at least one electrical output terminal; each of the electrical input terminals are configured to input a corresponding electrical signal, and the electrical output terminal is configured to output an electrical signal, thus forming a closed circuit between the electrical input terminals and the electrical output terminal; the electrical input terminals and the electrical output terminal are connected respectively to the electrodes correspondingly; while the electrical signal adjusting circuit is configured to adjust a magnitude of the electrical signal applied to the electrodes.

Further, the electrodes are arranged as four: a first electrode, a second electrode, a third electrode, and a fourth electrode respectively; the first electrode and the second electrode are arranged at both ends of the P-type doped region, the third electrode and the fourth electrode are arranged at both ends of the N-type doped region; the electrical input terminals are arranged as two: a first electrical input terminal and a second electrical input terminal respectively; the electrical output terminals are arranged as two: a first electrical output terminal and a second electrical output terminal; the first electrical input terminal is connected to the first electrode, the second electrical input terminal is connected to the third electrode, the first electrical output terminal is connected to the second electrode, and the second electrical output terminal is connected to the fourth electrode; by the electrical signal adjusting circuit adjusting the magnitude of the electrical signal being input, a voltage input by the first electrical input terminal is as same as or different from a voltage input by the second electrical input terminal.

Further, the electrodes are arranged as four: a first electrode, a second electrode, a third electrode, and a fourth electrode respectively, the first electrode and the second electrode are arranged at both ends of the P-type doped region, the third electrode and the fourth electrode are arranged at both ends of the N-type doped region; the electrical input terminals are arranged as two: a first electrical input terminal and a second electrical input terminal respectively; the electrical output terminals are arranged as two: a first electrical output terminal and a second electrical output terminal respectively; the first electrical input terminal is connected to the first electrode, the second electrical input terminal is connected to the second electrode, the first electrical output terminal is connected to the third electrode, and the second electrical output terminal is connected to the fourth electrode; by the electrical signal adjusting circuit adjusting the magnitude of the electrical signal being input, the voltage input by the first electrical input terminal is as same as the voltage input by the second electrical input terminal.

Further, the electrodes are arranged as four: a first electrode, a second electrode, a third electrode, and a fourth electrode respectively; the first electrode and the second electrode are arranged at both ends of the P-type doped region, the third electrode and the fourth electrode are arranged at both ends of the N-type doped region; the electrical input terminals are arranged as two: a first electrical input terminal and a second electrical input terminal respectively; the electrical output terminals are arranged as two: a first electrical output terminal and a second electrical output terminal respectively; the first electrical input terminal is connected to the first electrode, the second electrical input terminal is connected to the second electrode, the first electrical output terminal is connected to the third electrode, and the second electrical output terminal is connected to the fourth electrode; by the electrical signal adjusting circuit adjusting the magnitude of the electrical signal being input, the voltage input by the first electrical input terminal is larger than the voltage input by the second electrical input terminal.

Further, the electrodes are arranged as four: a first electrode, a second electrode, a third electrode, and a fourth electrode respectively; the first electrode and the second electrode are arranged at both ends of the P-type doped region, the third electrode and the fourth electrode are arranged at both ends of the N-type doped region; the electrical input terminals are arranged as three: a first electrical input terminal, a second electrical input terminal and a third electrical input terminal respectively; the electrical output terminal is arranged as one; the first electrical input terminal is connected to the first electrode, the second electrical input terminal is connected to the second electrode, the third electrical input terminal is connected to the third electrode, and the electrical output terminal is connected to the fourth electrode; by the electrical signal adjusting circuit adjusting the magnitude of the electrical signal being input, the voltage input by the first electrical input terminal is greater than the voltage input by the second electrical input terminal, and the voltage input by the second electrical input terminal is as same as the voltage input by the third electrical input terminal.

Further, the electrodes is arranged as four: a first electrode, a second electrode, a third electrode, and a fourth electrode respectively; the first electrode and the second electrode are arranged at both ends of the P-type doped region, the third electrode and the fourth electrode are arranged at both ends of the N-type doped region; the electrical input terminals are arranged as three: a first electrical input terminal, a second electrical input terminal and a third electrical input terminal respectively; the electrical output terminal is arranged as one; the first electrical input terminal is connected to the first electrode, the second electrical input terminal is connected to the second electrode, the third electrical input terminal is connected to the third electrode, and the electrical output terminal is connected to the fourth electrode; by the electrical signal adjusting circuit adjusting the magnitude of the electrical signal being input, the voltage input by the first electrical input terminal is greater than the voltage input by the second electrical input terminal, and the voltage input by the second electrical input terminal is greater than the voltage input by the third electrical input terminal.

Further, the electrodes are arranged as three: a first electrode, a second electrode and a third electrode; the first electrode and the second electrode are arranged at both ends of the P-type doped region and the third electrode is arranged in a middle of the N-type doped region; the electrical input terminals are arranged as two: a first electrical input terminal and a second electrical input terminal respectively; the electrical output terminal is arranged as one; the first electrical input terminal is connected to the first electrode, the second electrical input terminal is connected to the second electrode, and the electrical output terminal is connected to the third electrode; by the electrical signal adjusting circuit adjusting the magnitude of the electrical signal, the voltage input by the first electrical input terminal is greater than the voltage input by the second electrical input terminal.

Further, a material of the optical waveguide comprises bulk-si, silicon-on-insulator (SOI), silicon-on-sapphire (SOS), Aluminum Oxide, Indium Phosphide, Lithium Niobate, Barium Titanate, and a plurality of polymers; the optical waveguide comprises a channel waveguide, a ridge waveguide, a slot waveguide, a diffusion waveguide, and a photonic crystal waveguide; a routing shape of the optical waveguide comprises a linear shape and a curved shape; a working wavelength range of the optical waveguide comprises a visible band, an O-band, an E-band, an S-band, a C-band, an L-band, a U-band, and a mid-infrared band; a plurality of the optical waveguides are arranged in a same layer, or in a plurality of independent layers correspondingly.

Further, the P-type doped region and/or the N-type doped region has a same impurity doping concentration, or a plurality of different impurity doping concentrations.

Further, the electrical signal is a fixed voltage or an adjustable voltage; a relative difference between the input voltages at each of the electrical input terminals is adjusted by the electrical signal adjusting circuit.

Further, according to a "time division multiplexing" method, the electrical signal adjusting circuit adjusts a voltage applied to the electrodes alternately at different time frames, thus enabling the ion-doped optical waveguide to act as both the optical phase shifter and the VOA at a same time.

The present disclosure further provides an ion-doped optical waveguide array, comprising:

a plurality of the ion-doped optical waveguides;

the ion-doped optical waveguides are arranged in an order to form an array, and two doping types of the doped regions located on a same side of any adjacent two of the ion-doped optical waveguides are same or opposite.

The present disclosure further provides a use method of the ion-doped optical waveguide, comprising:

the electrical signal adjusting circuit adjusting the magnitude of an electrical signal applied to an electrode correspondingly, thereby enabling the ion-doped optical waveguide to act as an optical phase shifter and/or a VOA.

Further, when the electrodes are arranged as four: a first electrode, a second electrode, a third electrode, and a fourth electrode respectively, the first electrode and the second electrode are arranged at both ends of the P-type doped region and the third electrode and the fourth electrode are arranged at both ends of the N-type doped region; the electrical input terminals are arranged as two: a first electrical input terminal and a second electrical input terminal; and the electrical output terminals are arranged as two: a first electrical output terminal and a second electrical output terminal;

connecting the first electrical input terminal to the first electrode, the second electrical input terminal to the third electrode, the first electrical output terminal to the second electrode, and the second electrical output terminal to the fourth electrode;

adjusting the magnitude of the electrical signal input by the electrical signal adjusting circuit, making the voltage input by the first electrical input terminal be able to be same as or different from the voltage input by the second electrical input terminal, while the current flows through the P-type doped region and N-type doped region in a direction parallel to the optical waveguide, thereby enabling the ion-doped optical waveguide to act as an optical phase shifter.

Further, when the electrodes are arranged as four: a first electrode, a second electrode, a third electrode, and a fourth electrode; the first electrode and the second electrode are arranged at both ends of the P-type doped region while the third electrode and the fourth electrode are arranged at both ends of the N-type doped region; the electrical input terminals are arranged as two: a first electrical input terminal and a second electrical input terminal; and the electrical output terminals are arranged as two: a first electrical output terminal and a second electrical output terminal;

connecting the first electrical input terminal to the first electrode, the second electrical input terminal to the second electrode, the first electrical output terminal to the third electrode, and the second electrical output terminal to the fourth electrode;

adjusting the magnitude of the electrical signal input by the electrical signal adjusting circuit, making the voltage input by the first electrical input terminal as same as the voltage input by the second electrical input terminal. While the current crosses the optical waveguide in a direction perpendicular to the optical waveguide, that is, flowing between the P-type doped region and the N-type doped region, thereby enabling the ion-doped optical waveguide to act as a VOA.

Further, when the electrodes are arranged as four: a first electrode, a second electrode, a third electrode, and a fourth electrode respectively; the first electrode and the second electrode are arranged at both ends of the P-type doped region, the third electrode and the fourth electrode are arranged at both ends of the N-type doped region; the electrical input terminals are arranged as two: a first electrical input terminal and a second electrical input terminal respectively; the electrical output terminals are arranged as two: a first electrical output terminal and a second electrical output terminal respectively;

connecting the first electrical input terminal to the first electrode, the second electrical input terminal to the second electrode, the first electrical output terminal to the third electrode, and the second electrical output terminal to the fourth electrode;

adjusting the magnitude of the electrical signal input by the electrical signal adjusting circuit, making the voltage input by the first electrical input terminal greater than the voltage input by the second electrical input terminal. At this time, the current flows through the P-type doped region in a direction parallel to the optical waveguide, while at a same time, the current crosses the optical waveguide in a direction perpendicular to the optical waveguide and flows from the P-type doped region to the N-type doped region, thereby enabling the ion-doped optical waveguide to act as both the optical phase shifter and the VOA at a same time.

Further, when the electrodes are arranged as four: a first electrode, a second electrode, a third electrode, and a fourth electrode respectively, the first electrode and the second electrode are arranged at both ends of the P-type doped region and the third electrode and the fourth electrode are arranged at both ends of the N-type doped region, the electrical input terminals are arranged as three: a first electrical input terminal, a second electrical input terminal and a third electrical input terminal respectively, and the electrical output terminal is arranged as one;

connecting the first electrical input terminal to the first electrode, the second electrical input terminal to the second electrode, the third electrical input terminal to the third electrode, and the electrical output terminal to the fourth electrode;

adjusting the magnitude of the electrical signal being input by the electrical signal adjusting circuit, making the voltage input by the first electrical input terminal greater than the voltage input by the second electrical input terminal, and the voltage input by the second electrical input terminal as same as the voltage input by the third electrical input terminal. At this time, the current flows through the P-type doped region and the N-type doped region in a direction parallel to the optical waveguide, while at a same time, the current crosses the optical waveguide in a perpendicular direction and flows from the P-type doped region to the N-type doped region, thereby enabling the ion-doped optical waveguide to act as an optical phase shifter and a VOA at a same time.

Further, when the electrodes are arranged as four: a first electrode, a second electrode, a third electrode, and a fourth electrode respectively; the first electrode and the second electrode are arranged at both ends of the P-type doped region, the third electrode and the fourth electrode are arranged at both ends of the N-type doped region; the electrical input terminals are arranged as three: a first electrical input terminal, a second electrical input terminal and a third electrical input terminal respectively; the electrical output terminal is arranged as one;

connecting the first electrical input terminal to the first electrode, the second electrical input terminal to the second electrode, the third electrical input terminal to the third electrode, and the electrical output terminal to the fourth electrode;

adjusting the magnitude of the electrical signal input by the electrical signal adjusting circuit, making the voltage input by the first electrical input terminal greater than the voltage input by the second electrical input terminal, and the voltage input by the second electrical input terminal is greater than the voltage input by the third electrical input terminal. At this time, the current flows through the P-type doped region and the N-type doped region in a direction parallel to the optical waveguide, while at a same time, the current crosses the optical waveguide in a perpendicular direction and flows from the P-type doped region to the N-type doped region, thereby enabling the ion-doped optical waveguide to act as an optical phase shifter and a VOA at a same time.

Further, when the electrodes are arranged as three: a first electrode, a second electrode and a third electrode respectively; the first electrode and the second electrode are arranged at both ends of the P-type doped region and the third electrode is arranged in a middle of the N-type doped region; the electrical input terminals are arranged as two: a first electrical input terminal and a second electrical input terminal respectively; the electrical output terminal is arranged as one;

connecting the first electrical input terminal to the first electrode, the second electrical input terminal to the second electrode, and the electrical output terminal to the third electrode;

adjusting the magnitude of the input electrical signal by the electrical signal adjusting circuit, making the voltage input by the first electrical input terminal greater than the voltage input by the second electrical input terminal. At this time, the current flows through the P-type doped region in a direction parallel to the optical waveguide, while at a same time, the current crosses the optical waveguide in a direction perpendicular to the optical waveguide and flows from the P-type doped region to the N-type doped region, thereby enabling the ion-doped optical waveguide to act as an optical phase shifter and a VOA at a same time.

As shown in the technical solutions described above, the present disclosure designs an ion-doped optical waveguide structure to ensure that, by using a same structure, it is able to realize both optical phase modulation and optical intensity attenuation. Thus, as required, the optical waveguide can be used either as an optical phase shifter along or a VOA alone, or even be used as both the optical phase shifter and the VOA simultaneously. At a same time, the present disclosure is able to achieve both functions of optical phase modulation and optical intensity attenuation in a same ion-doped optical waveguide structure, thus saving a lot of spaces in a chip, that is, reducing a size of the chip, further saving a cost. Moreover, the use method disclosed by the present disclosure is flexible, being able to meet a plurality of application requirements in a variety of specific scenarios, especially in a large-scale multi-channel photonic integrated circuit.

### BRIEF DESCRIPTION OF DRAWINGS

FIG. 1 illustrates a schematic diagram on an optical phase shifter in the prior art;

FIG. 2 illustrates a schematic diagram on a VOA in the prior art;

FIG. 3 illustrates a schematic diagram on an ion-doped optical waveguide structure excluding an electrical signal adjusting circuit according to an embodiment of the present disclosure;

FIGS. 4-9 illustrate schematic diagrams on an ion-doped optical waveguide structure according to an embodiment of the present disclosure;

FIG. 10 and FIG. 11 illustrate schematic structural diagrams on an ion-doped optical waveguide array according to an embodiment of the present disclosure; and

FIG. 12 illustrates a schematic diagram on an ion-doped optical waveguide structure having different doping concentrations according to an embodiment of the present disclosure.

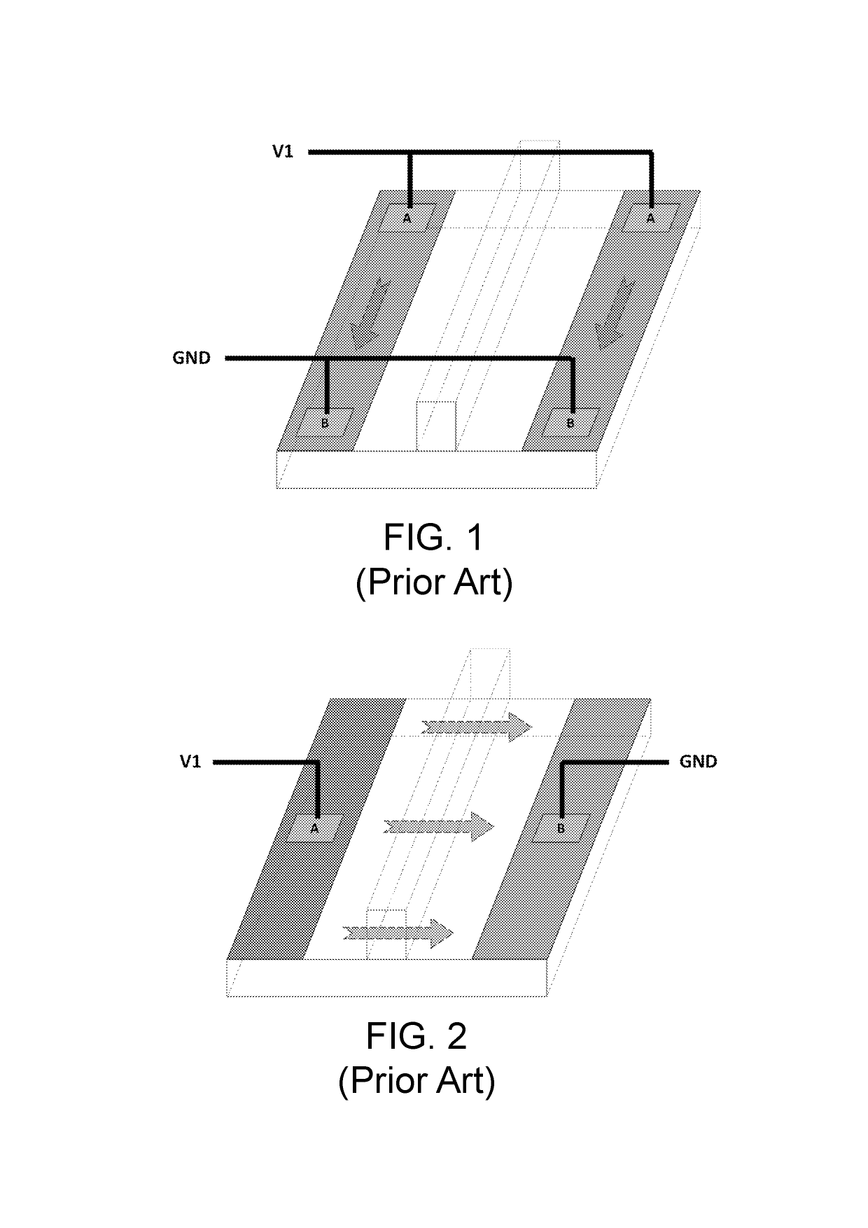

### DETAILED DESCRIPTION OF EMBODIMENTS

In order to make the objectives, technical solutions and advantages of the embodiments in the present disclosure clearer and more explicit, the technical solutions in the embodiments of the present disclosure will be clearly and completely described below. Obviously, the embodiments mentioned herein are part of the embodiments of the present disclosure, instead of all of the embodiments. According to the embodiments of the present disclosure, all other embodiments achieved by common technicians in the art without any creative effort are all within the scope of protection of the present disclosure. Unless otherwise defined, technical or scientific terms used herein shall have the meanings commonly understood by those of ordinary skills in the art to which the present disclosure belongs. The term "comprise" and other similar terms used herein are intended to indicate that the component or item appearing before the term includes the component or item appearing after the word and the equivalents thereof, without excluding any other components or items.

The specific embodiments of the present disclosure are described hereafter in further details below with reference to the accompanying drawings.

An embodiment of the present disclosure provides an ion-doped optical waveguide structure, comprising: an optical waveguide; a plurality of doped regions, comprising a P-type doped region and an N-type doped region arranged respectively on both sides of the optical waveguide, while the P-type doped region and the N-type doped region are isolated from each other; a plurality of electrodes, arranged on the P-type doped region and the N-type doped region; and an electrical signal adjusting circuit, comprising a plurality of electrical input terminals and at least one electrical output terminal. The electrical input terminal inputs a corresponding electrical signal, and the electrical output terminal outputs an electrical signal, thus forming a closed circuit between the electrical input terminals and the electrical output terminal. The electrical input terminals and the electrical output terminal are connected respectively to the electrodes correspondingly, and the electrical signal adjusting circuit is configured to adjust a magnitude of the electrical signal applied to the electrodes.

An embodiment of the present disclosure further provides a use method of the ion-doped optical waveguide, comprising: the electrical signal adjusting circuit adjusting the magnitude of an electrical signal applied to an electrode correspondingly, thereby enabling the ion-doped optical waveguide to realize an optical phase shifter and/or a VOA.

In a plurality of embodiments of the present disclosure, a material of the optical waveguide includes but is not limited to, bulk-si, silicon-on-insulator, silicon-on-sapphire, aluminum oxide, indium phosphide, lithium niobate, barium titanate, and a plurality of polymers. The optical waveguide includes but are not limited to, a channel waveguide, a ridge waveguide, a slot waveguide, a diffusion waveguide, and a photonic crystal waveguide. The optical waveguide is not limited to a linear waveguide, but includes a bent waveguide and a plurality of various curved waveguides. The optical waveguide can be arranged in a same layer or extended to a plurality of layers. A material, a height, a number of layers of a conductive metal, a via hole and more in an electrode region can be arranged as required. A working wavelength range of the optical waveguide includes but is not limited to, a visible band, an O-band, an E-band, an S-band, a C-band, an L-band, a U-band, and a mid-infrared band.

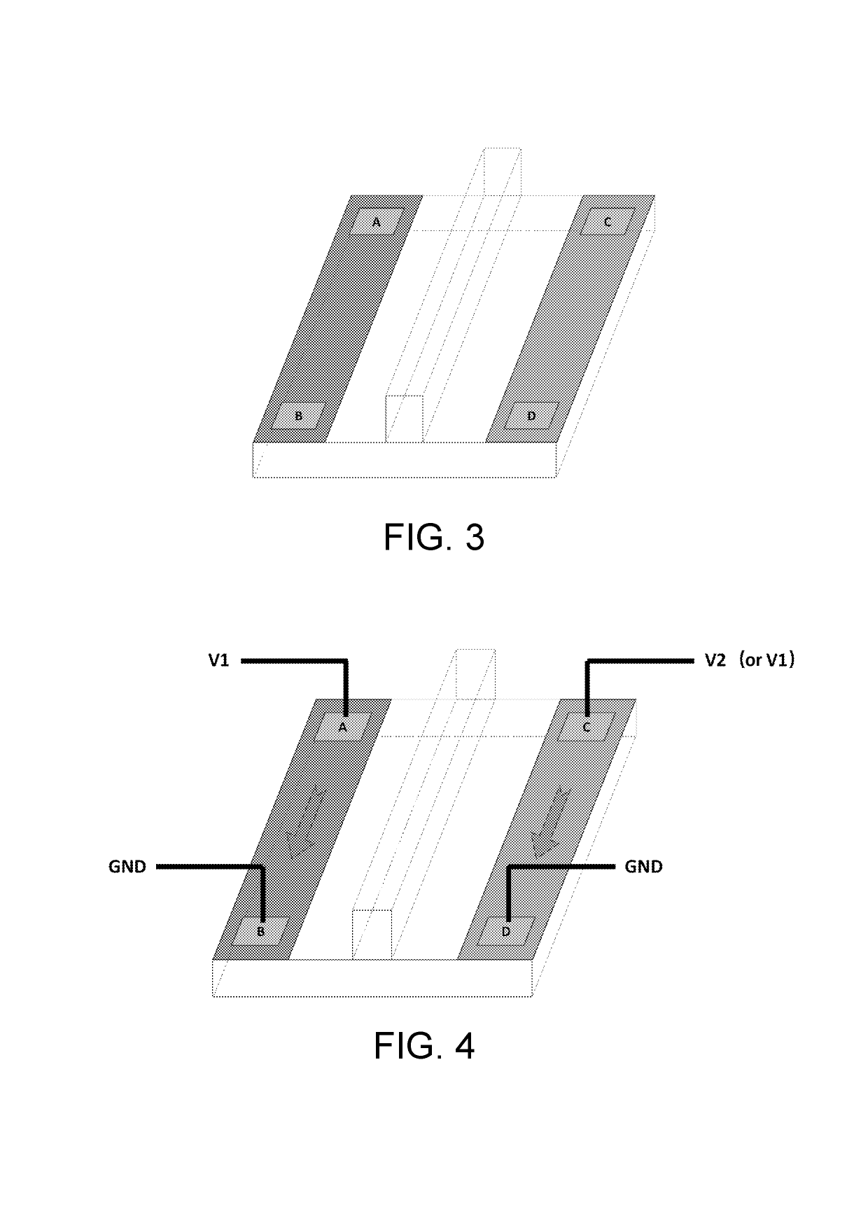

Referencing to FIG. 3, in a plurality of embodiments of the present disclosure, a type of the optical waveguide is a ridge waveguide. A plurality of regions on both left side and right side of the optical waveguide (left and right directions shown in FIG. 2) contain P-type ion doping and N-type ion doping respectively, further having a resistance characteristic, before forming the P-type doped region and the N-type doped region. Both ends of the P-type doped region have a first electrode A and a second electrode B arranged respectively, and both ends of the N-type doped region have a third electrode C and a fourth electrode D arranged respectively. Four of the electrodes, specifically, may comprise one or more layers of conductive metals, via holes, ohmic contacts, and more (not shown in the figure), configured to induce an external electrical signal into the ion-doped regions.

Referencing to FIG. 4, in a plurality of embodiments of the present disclosure, both ends of the P-type doped region have a first electrode A and a second electrode B arranged respectively, and both ends of the N-type doped region have a third electrode C and a fourth electrode D arranged respectively. The electrical input terminals comprise a first electrical input terminal and a second electrical input terminal respectively, and the electrical output terminals comprise a first electrical output terminal and a second electrical output terminal respectively. The first electrical input terminal is connected to the first electrode A, the second electrical input terminal is connected to the third electrode C, the first electrical output terminal is connected to the second electrode B, and the second electrical output terminal is connected to the fourth electrode D. In a real implementation, an electrical signal V1 and an electrical signal GND are applied to the first electrode A and the second electrode B respectively, while a electrical signal V2 and an electrical signal GND are applied to the third electrode C and the fourth electrode D respectively. The electrical signal adjusting circuit is adjusted to control a magnitude of the electrical signals input by the first electrical input terminal and the second electrical input terminal. Wherein, a voltage input by the first electrical input terminal is adjusted to be same as or different from a voltage input by the second electrical input terminal, that is, V1 may be equal to V2 (the electrical signal V1 is applied to both the first electrode A and the third electrode C), or V1 may be unequal to V2, and a current will be generated at this moment. As shown by a plurality of arrows in FIG. 4, the current flows through the P-type doped region and the N-type doped region in a direction parallel to the optical waveguide, and when resistance is formed, thermal energy is generated and conducted to the optical waveguide. Further a refractive index of the optical waveguide is changed by a thermo-optic effect, making a phase change happen of an optical wave traveling through the optical waveguide, that is, an optical phase shifter is achieved.

A magnitude of the voltage applied to each electrode can be arranged and adjusted as required by the electrical signal adjusting circuit, thereby generating a plurality of different current intensities and achieving a plurality of different functions, so as to meet a plurality of different specific requirements. In an embodiment shown in FIG. 4, by adjusting a relative difference between the voltage V1 input by the first electrical input terminal and the voltage V2 input by the second electrical input terminal, it is possible to make a heating amount on each side of the optical waveguide different, further producing different thermal diffusion effects on both sides of the optical waveguide, which is applicable to an application having a certain specific requirement.

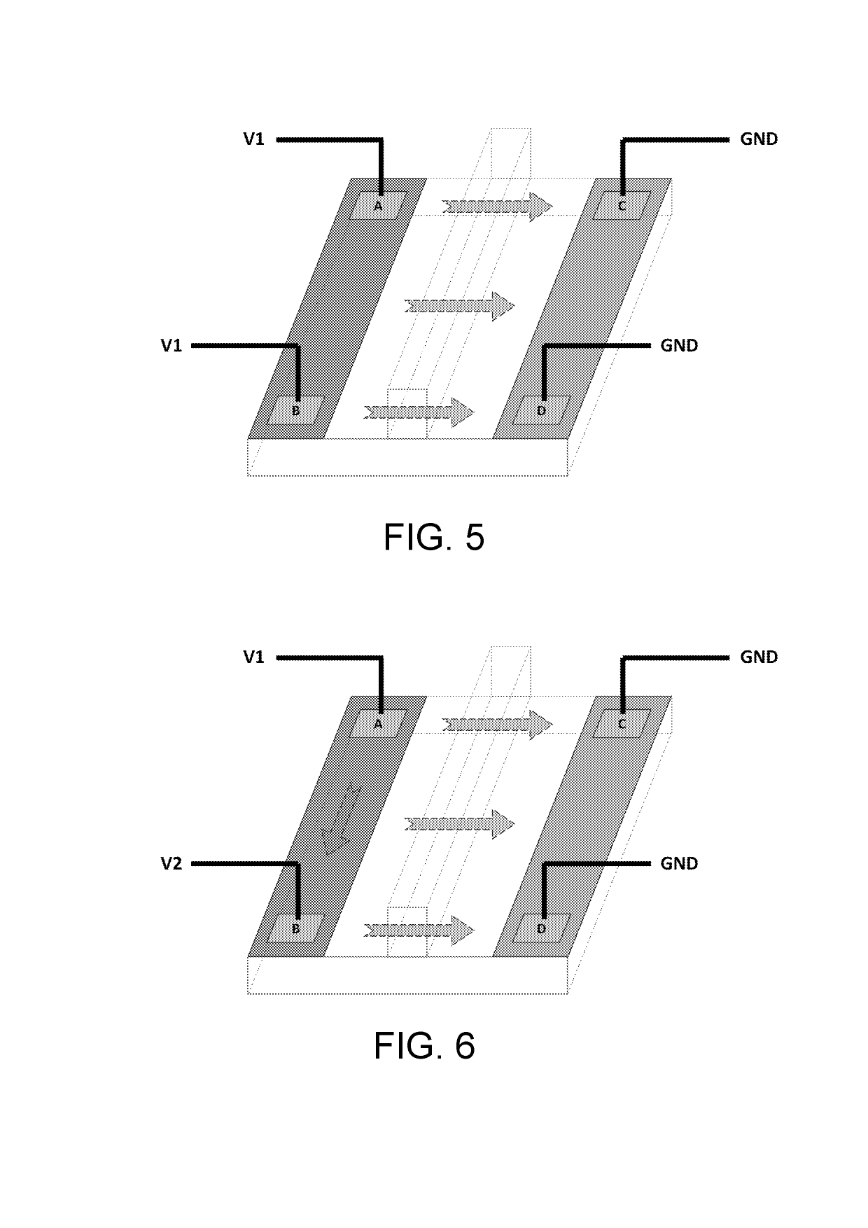

Referencing to FIG. 5, in a plurality of embodiments of the present disclosure, both ends of the P-type doped region have a first electrode A and a second electrode B arranged respectively, while both ends of the N-type doped region have a third electrode C and a fourth electrode D arranged respectively. The electrical input terminals comprise a first electrical input terminal and a second electrical input terminal respectively, and the electrical output terminals comprise a first electrical output terminal and a second electrical output terminal respectively. The first electrical input terminal is connected to the first electrode A, the second electrical input terminal is connected to the second electrode B, the first electrical output terminal is connected to the third electrode C, and the second electrical output terminal is connected to the fourth electrode D. In a real implementation, a same electrical signal V1 is applied to the first electrode A and the second electrode B, and a same electrical signal GND is applied to the third electrode C and the fourth electrode D, thus a current is generated between two doped regions of the P-type doped region and the N-type doped region. As shown by a plurality of arrows in FIG. 5, the current crosses the optical waveguide in a direction perpendicular to the optical waveguide and flows from the P-type doped region to the N-type doped region. At this time, a plurality of carriers in the current will absorb photons when passing through the optical waveguide, further changing an intensity of the optical waves traveling through the optical waveguide, thus a VOA is achieved, which belongs to a carrier-injection variable optical attenuator.

When it is required to use an optical phase shifter and a VOA successively, it is possible to apply a plurality of voltage signals required onto the first electrode A, the second electrode B, the third electrode C and the fourth electrode D in an order. That is, the embodiments as shown in FIG. 4 and FIG. 5, are acting as the optical phase shifter and the VOA respectively.

In a plurality of embodiments of the present disclosure, it is possible to apply the required voltage signals to the first electrode A, the second electrode B, the third electrode C and the fourth electrode D alternately at a different time frame following a "time division multiplexing" method, so as to act as an optical phase shifter and a VOA almost simultaneously.

Referencing to FIG. 6, in a plurality of embodiments of the present disclosure, both ends of the P-type doped region have a first electrode A and a second electrode B arranged respectively, while both ends of the N-type doped region have a third electrode C and a fourth electrode D arranged respectively. The electrical input terminals comprise a first electrical input terminal and a second electrical input terminal respectively, and the electrical output terminals comprise a first electrical output terminal and a second electrical output terminal. The first electrical input terminal is connected to the first electrode A, the second electrical input terminal is connected to the second electrode B, the first electrical output terminal is connected to the third electrode C, and the second electrical output terminal is connected to the fourth electrode D. In a real implementation, the electrical signals V1 and V2 are applied to the first electrode A and the second electrode B respectively, and the electrical signal GND is applied to the third electrode C and the fourth electrode D. The electrical signal adjusting circuit is adjusted to control a magnitude of the electrical signal input by the first electrical input terminal and the second electrical input terminal, until the voltage input by the first electrical input terminal is greater than the voltage input by the second electrical input terminal, that is, V1>V2. As shown by a plurality of arrows in FIG. 6, the current flows through the P-type doped region in a direction parallel to the optical waveguide, generates thermal energy and conducting the thermal energy to the optical waveguide, before changing the refractive index of the optical waveguide by the thermo-optic effect and leading to a phase change of the optical waves traveling through the optical waveguide, thus realizing an optical phase shifter at that time; at a same time, the current crosses the optical waveguide in a direction perpendicular to the optical waveguide and flows from the P-type doped region to the N-type doped region, absorbing photons,and making the intensity of the optical waves traveling through the optical waveguide have a change happen, thus a VOA is achieved. Therefore, the present embodiment is able to act as an optical phase shifter and a VOA at a same time.

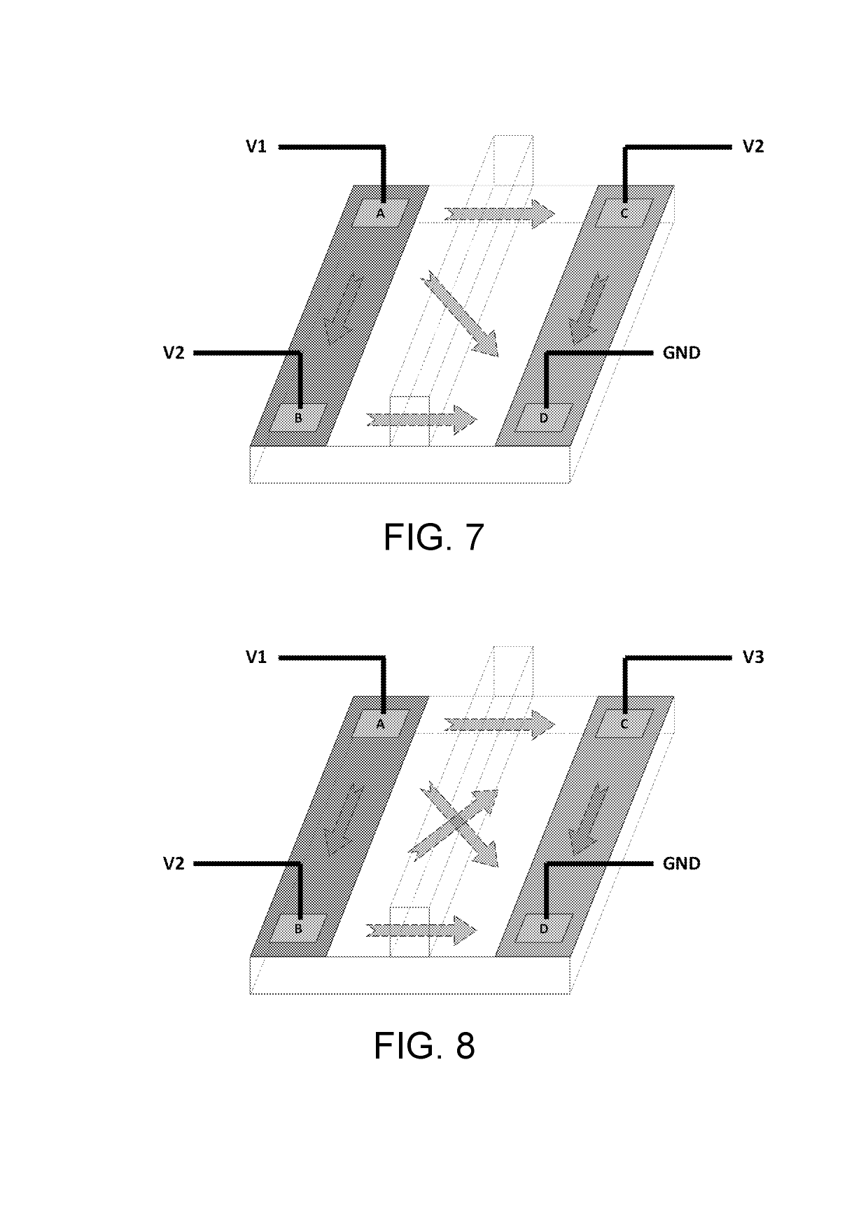

Referencing to FIG. 7, in a plurality of embodiments of the present disclosure, both ends of the P-type doped region have a first electrode A and a second electrode B arranged respectively while both ends of the N-type doped region have a third electrode C and a fourth electrode D arranged respectively. The electrical input terminals comprise a first electrical input terminal, a second electrical input terminal and a third electrical input terminal, while the electrical output terminal has one. The first electrical input terminal is connected to the first electrode A, the second electrical input terminal is connected to the second electrode B, the third electrical input terminal is connected to the third electrode C, and the electrical output terminal is connected to the fourth electrode D. In a real implementation, an electrical signal V1 is applied to the first electrode A, an electrical signal V2 is applied to the second electrode B and the third electrode C, and an electrical signal GND is applied to the electrical output terminal. The electrical signal adjusting circuit is adjusted to control the magnitudes of the electrical signals input by the first electrical input terminal, the second electrical input terminal, and the third electrical input terminal, until the voltage input by the first electrical input terminal is greater than the voltage input by the second electrical input terminal and the third electrical input terminal, that is, V1>V2. Shown as a plurality of arrows in FIG. 7, the current flows through the P-type doped region and the N-type doped region in a direction parallel to the optical waveguide, generating thermal energy before conducting to the optical waveguide, further changing the refractive index of the optical waveguide through the thermo-optic effect and leading to a phase change of the optical wave traveling through the optical waveguide, before realizing an optical phase shifter. At a same time, the current also crosses the optical waveguide and flows from the P-type doped region to the N-type doped region, that is, there is a current flowing between two of the doped regions, while photon absorption happens at a same time, making the intensity of the optical wave traveling through the optical waveguide change, thus a VOA is achieved. Therefore, the present embodiment can act as an optical phase shifter and a VOA at a same time.

Referencing to FIG. 8, in a plurality of embodiments of the present disclosure, both ends of the P-type doped region have a first electrode A and a second electrode B arranged respectively while both ends of the N-type doped region have a third electrode C and a fourth electrode D arranged respectively. The electrical input terminals comprise a first electrical input terminal, a second electrical input terminal and a third electrical input terminal, and the electrical output terminal is one. The first electrical input terminal is connected to the first electrode A, the second electrical input terminal is connected to the second electrode B, the third electrical input terminal is connected to the third electrode C, and the electrical output terminal is connected to the fourth electrode D. In a real implementation, three electrical signals V1, V2 and V3 are applied to the first electrode A, the second electrode B, and the third electrode C respectively, and an electrical signal GND is applied to the electrical output terminal. The electrical signal adjusting circuit is adjusted to control the magnitudes of the electrical signals input by the first electrical input terminal, the second electrical input terminal, and the third electrical input terminal, until the voltage input by the first electrical input terminal is greater than the voltage input by the second electrical input terminal and the voltage input by the second electrical input terminal is greater than the voltage input by the third electrical input terminal, that is, V1>V2>V3. Shown as a plurality of arrows in FIG. 8, there are currents flowing through the P-type doped region between the first electrode A and the second electrode B and the N-type doped region between the third electrode C and the fourth electrode D, generating the thermal energy and conducting the thermal energy to the optical waveguide, before changing the refractive index of the optical waveguide and realizing an optical phase shifter; at a same time, there is a current flowing between the P-type doped region and the N-type doped region locating on both sides of the optical waveguide respectively, (Note: a direction of the arrow is only for reference, at a real implementation, an actual current direction may be more complicated in the present situation, however an effect remains that there is a current crossing the optical waveguide) crossing the optical waveguide and absorbing the photons, before a VOA is achieved. Therefore, the present embodiment can act as an optical phase shifter and an VOA at a same time.

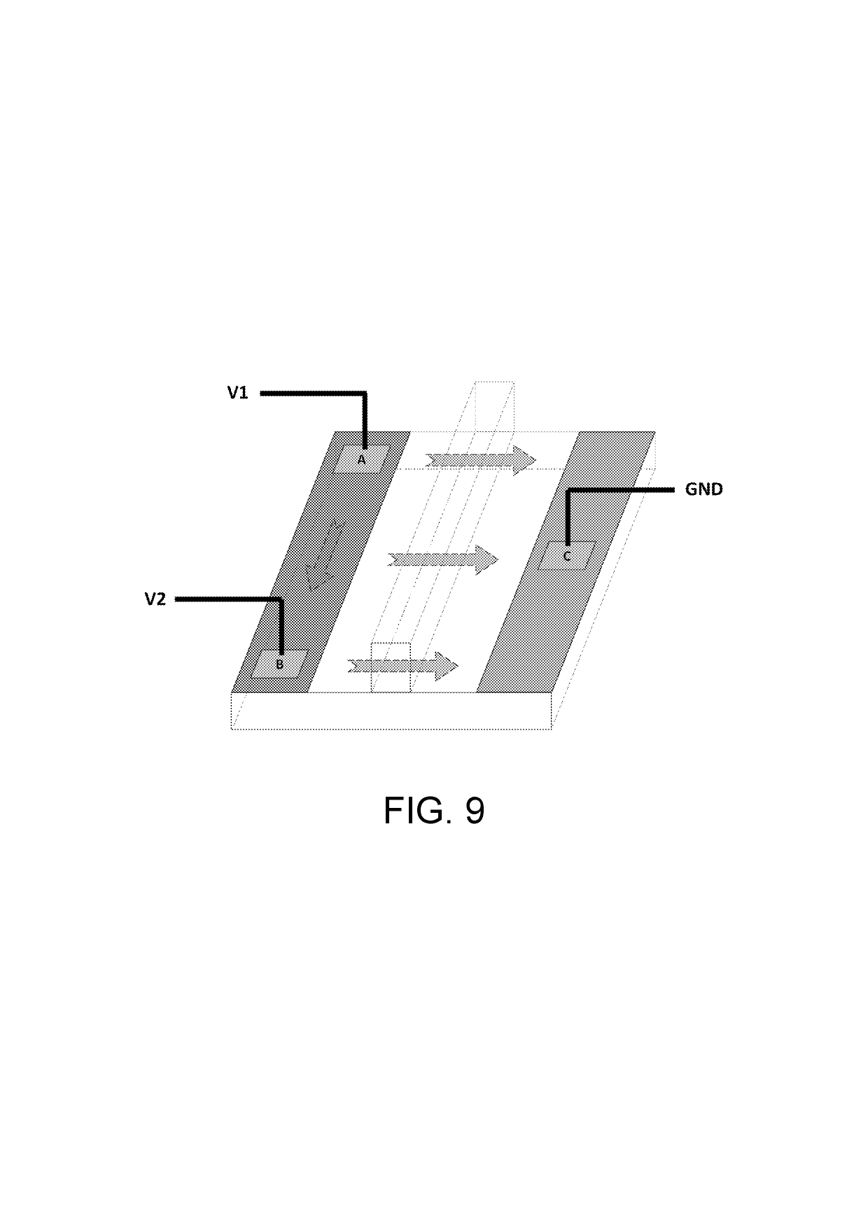

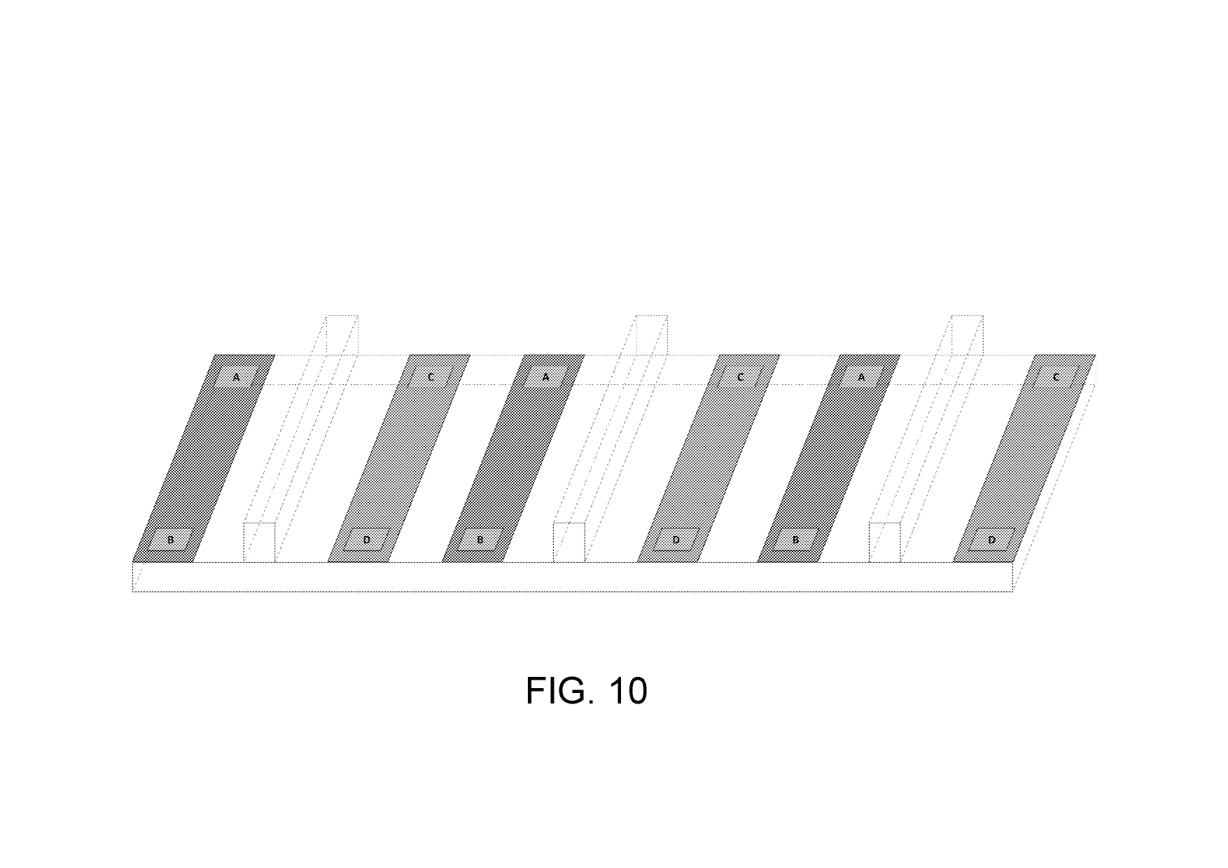

Referencing to FIG. 9, in a plurality of embodiments of the present disclosure, both ends of the P-type doped region have a first electrode A and a second electrode B arranged respectively while a middle of the N-type doped region has a third electrode C arranged. The electrical input terminals comprise a first electrical input terminal and a second electrical input terminal, and the electrical output terminal is arranged as one. The first electrical input terminal is connected to the first electrode A, the second electrical input terminal is connected to the second electrode B, and the electrical output terminal is connected to the third electrode C. In a real implementation, two electrical signals V1 and V2 are applied to the first electrode A and the second electrode B respectively, and an electrical signal GND is applied to the electrical output terminal. The electrical signal adjusting circuit is adjusted to control the magnitude of the electrical signals input by the first electrical input terminal and the second electrical input terminal, until the voltage input by the first electrical input terminal is greater than the voltage input by the second electrical input terminal, that is, V1>V2. Shown as a plurality of arrows in FIG. 9, there is a current flowing through the P-type doped region between the first electrode A and the second electrode B, generating thermal energy before conducting the thermal energy to the optical waveguide, thus the refractive index of the optical waveguide is changed, further an optical phase shifter is achieved; At a same time, there is also a current flowing through the P-type doped region and the N-type doped region on both sides of the optical waveguide, crossing the optical waveguide and absorbing the photons , thus a VOA is achieved. Therefore, the present embodiment can act as an optical phase shifter and a VOA at a same time. When only one side of the optical waveguide is heated for a phase shift, the present embodiment may be applied.

A carrier-injection based variable optical attenuator has a certain optical phase change during a process of optical attenuation (determined by a physical mechanism). In a plurality of applications, it is often necessary to achieve an optical attenuation effect without an additional optical phase change happen, or it is needed to keep the additional optical phase change within a certain range. Therefore, by adopting the embodiments shown in FIGS. 6-9, it is possible to cancel out, weaken, or compensate the additional optical phase change unnecessarily generated during a process of optical attenuation, that is, an overall optical phase change is optimized or adjusted effectively, in order to meet a requirement of a specific application.

An embodiment of the present disclosure further provides an ion-doped optical waveguide array, comprising: a plurality of ion-doped optical waveguides; the ion-doped optical waveguides are arranged in a sequence and forming an array, while two doped types of the doped regions located on a same side of any two adjacent ion-doped optical waveguides are same or opposite.

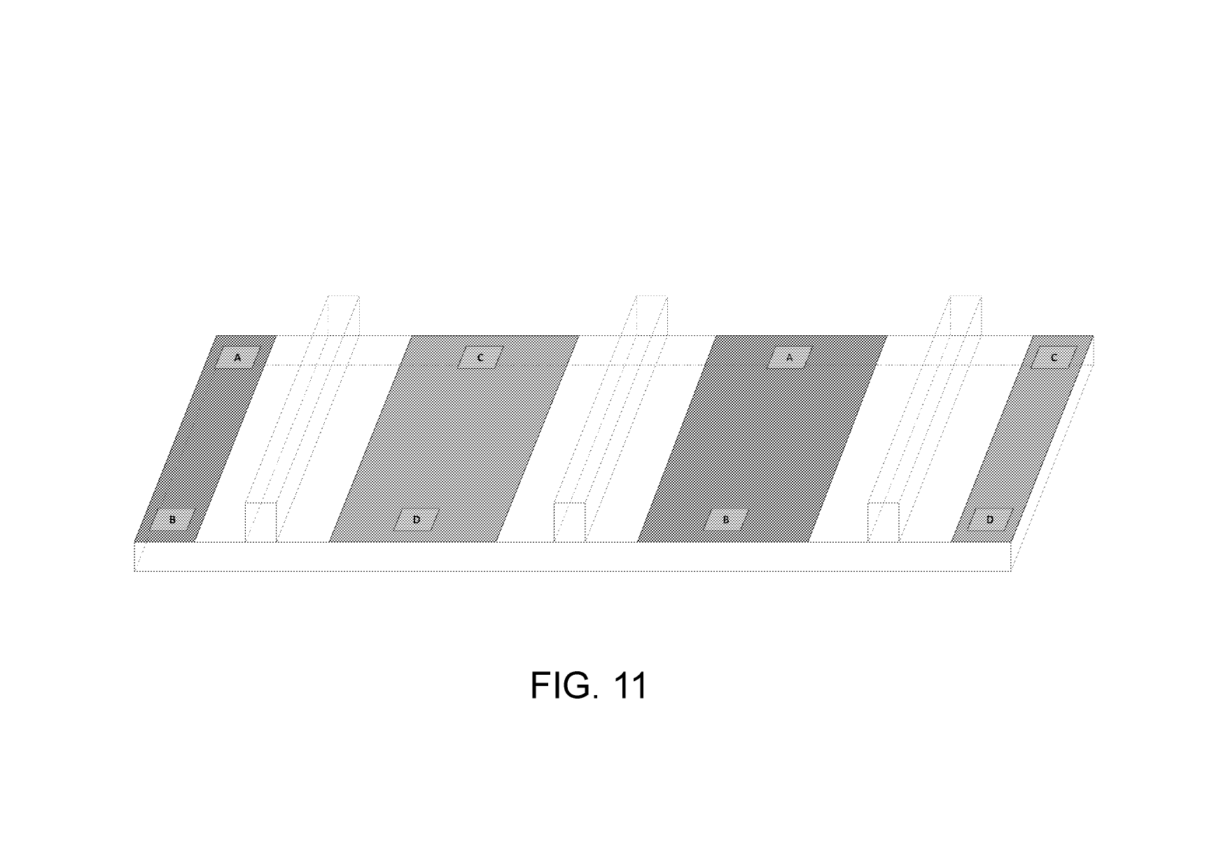

Referencing to FIG. 10, in a plurality of embodiments of the present disclosure, there are three ion-doped optical waveguides arranged from left to right (left and right directions shown in FIG. 10): a first ion-doped optical waveguide, a second ion-doped optical waveguide and a third ion-doped optical waveguide, respectively. Three of the optical waveguides are arranged in a sequence to form an array. Two doped regions located on a same side of the first ion-doped optical waveguide and the second ion-doped optical waveguide are an N-type doped region (the doped region where the third electrode C and the fourth electrode D are located) and a P-type doped region (the doped region where the first electrode A and the second electrode B are located) respectively. Two doped regions located on a same side of the third ion-doped optical waveguide and the fourth ion-doped optical waveguide are an N-type doped region and a P-type doped region respectively, that is, the doping types are opposite.

Referencing to FIG. 11, in a plurality of embodiments of the present disclosure, there are three ion-doped optical waveguides, from left to right (the left and the right directions shown in FIG. 11): the first ion-doped optical waveguide, the second ion-doped optical waveguide and the third ion-doped optical waveguide respectively, and three of the optical waveguides are arranged in a sequence to form an array. Two doped regions located on a same side of the first ion-doped optical waveguide and the second ion-doped optical waveguide are an N-type doped region (the region where the third electrode C and the fourth electrode D are located) and an N-type doped region respectively; the doped regions located on a same side of the third ion-doped optical waveguide and the fourth ion-doped optical waveguide are a P-type doped region (the region where the first electrode A and the second electrode B are located) and a P-type doped region respectively, that is, the doping types are same, and at this time, it is possible to connect the doped regions together or share a doped region.

For a specific use method of the ion-doped optical waveguide array, please refer to the use method of the ion-doped optical waveguide.

In a plurality of embodiments of the present disclosure, two doped regions on both left and right sides of each optical waveguide in the ion-doped optical waveguide or an array may have a same doping concentration, or have a plurality of different doping concentrations, that is, a certain concentration gradient is formed.

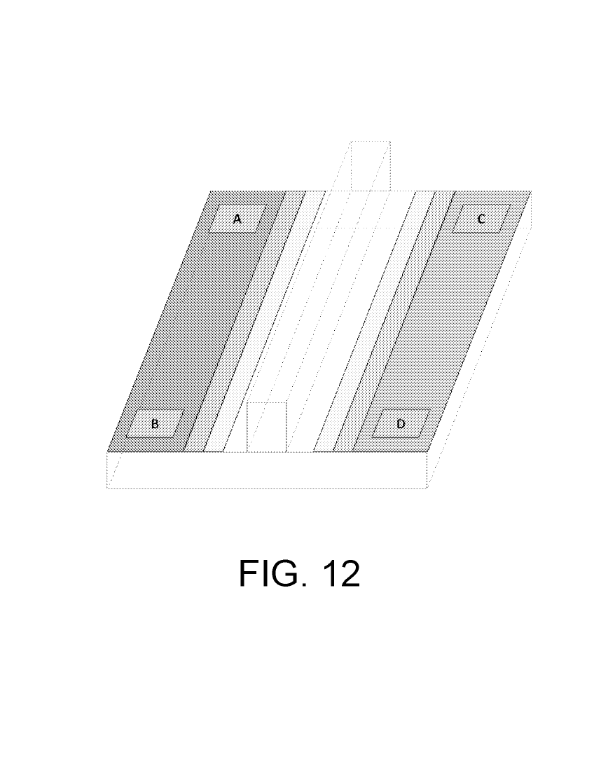

Referencing to FIG. 12, in a plurality of embodiments of the present disclosure, each of the P-type doped region and the N-type doped region on both sides of the optical waveguide has three different doping concentrations, applied to specific application scenarios as required.

In any one of the embodiments stated above, the electrical signal applied may have a fixed voltage or an adjustable voltage. The adjustable voltage can be achieved for a voltage output and flexible control by a plurality of methods including an adjustable circuit. In addition to a voltage source, a current source may also be applied as a signal source.

In a plurality of embodiments of the present disclosure, the optical waveguide and the optical waveguide array may have an air wall or an air groove (such as an air-filled closed cavity or an air opening) arranged around, applied for a thermal insulation, so as to improve a heating efficiency of the phase shifter. In a plurality of other embodiments of the present disclosure, the optical waveguide and the optical waveguide array may have no air wall or air groove arranged around.

In a plurality of embodiments of the present disclosure, a distance of the ion doping optical waveguide can be arranged as required, so as to balance a plurality of indicators including optical absorption loss and an efficiency.

All above, the present disclosure designs an ion-doped optical waveguide structure, being able to modulate both the optical phase and the optical intensity, thus being able to be applied as an optical phase shifter or a VOA solely, and even configured to act as both the optical phase shifter and the VOA simultaneously. Therefore, the present disclosure saves a lot of spaces in a chip, that is, reduces a size of the chip, further reducing a cost. Moreover, the use method disclosed in the present disclosure is flexible, being able to meet a plurality of application requirements in a plurality of specific scenarios, being able to be applied in a plurality of fields including optical communication, optical interconnection, a laser radar, light beam control, optical sensing, free-space optical communication, optical storage, optical computing, optical gyroscope and virtual reality and more.

Although a plurality of the embodiments of the present disclosure having been described in details above, it is apparent to the technicians in the art that various modifications and variations may be made to the embodiments described above. However, it should be appreciated that such modifications and variations belong to the scope and intention of the present disclosure as described in the claims. In addition, there may be a plurality of other embodiments of the present disclosure described herein, which can be implemented or realized in various ways.

What is claimed is:

1. An ion-doped optical waveguide structure, comprising:
an optical waveguide;
a doped region, comprising a P-type doped region and an N-type doped region arranged respectively on both sides of the optical waveguide, while the P-type doped region and the N-type doped region are isolated from each other;
a plurality of electrodes, the electrodes are arranged on the P-type doped region and the N-type doped region; and
an electrical signal adjusting circuit, comprising a plurality of electrical input terminals and at least one electrical output terminal, wherein each of the electrical input terminals inputs a corresponding electrical signal, and the electrical output terminal outputs an electrical signal, so as to form a closed circuit between the electrical input terminals and the electrical output terminal; the electrical input terminals and the electrical output terminal are connected respectively to the electrodes correspondingly; and the electrical signal adjusting circuit is configured to adjust a magnitude of the electrical signal applied to the electrodes.

2. The ion-doped optical waveguide structure according to claim 1, wherein the electrodes are arranged as four: a first electrode, a second electrode, a third electrode, and a fourth electrode respectively; the first electrode and the second electrode are arranged at both ends of the P-type doped region, and the third electrode and the fourth electrode are arranged at both ends of the N-type doped region; the electrical input terminals are arranged as two: a first electrical input terminal and a second electrical input terminal respectively; the electrical output terminals are arranged as two: a first electrical output terminal and a second electrical output terminal respectively; the first electrical input terminal is connected to the first electrode, the second electrical input terminal is connected to the third electrode, the first electrical output terminal is connected to the second electrode, and the second electrical output terminal is connected to the fourth electrode; and the electrical signal adjusting circuit is configured to adjust the magnitude of the electrical signal being input, until a voltage input by the first electrical input terminal is as same as or different from a voltage input by the second electrical input terminal.

3. The ion-doped optical waveguide structure according to claim 1, wherein the electrodes are arranged as four: a first electrode, a second electrode, a third electrode, and a fourth electrode respectively; the first electrode and the second electrode are arranged at both ends of the P-type doped region, and the third electrode and the fourth electrode are arranged at both ends of the N-type doped region; the electrical input terminals are arranged as two: a first electrical input terminal and a second electrical input terminal respectively; the electrical output terminals are arranged as two: a first electrical output terminal and a second electrical output terminal respectively; the first electrical input terminal is connected to the first electrode, the second electrical input terminal is connected to the second electrode, the first electrical output terminal is connected to the third electrode, and the second electrical output terminal is connected to the fourth electrode; and the electrical signal adjusting circuit is configured to adjust the magnitude of the electrical signal being input, until a voltage input by the first electrical input terminal is as same as a voltage input by the second electrical input terminal.

4. The ion-doped optical waveguide structure according to claim 1, wherein the electrodes are arranged as four: a first electrode, a second electrode, a third electrode, and a fourth electrode respectively; the first electrode and the second electrode are arranged at both ends of the P-type doped region, the third electrode and the fourth electrode are arranged at both ends of the N-type doped region; the electrical input terminals are arranged as two: a first electrical input terminal and a second electrical input terminal respectively; the electrical output terminals are arranged as two: a first electrical output terminal and a second electrical output terminal respectively; the first electrical input terminal is connected to the first electrode, the second electrical input terminal is connected to the second electrode, the first electrical output terminal is connected to the third electrode, and the second electrical output terminal is connected to the fourth electrode; and the electrical signal adjusting circuit is configured to adjust the magnitude of the electrical signal being input, until a voltage input by the first electrical input terminal is larger than a voltage input by the second electrical input terminal.

5. The ion-doped optical waveguide structure according to claim 1, wherein the electrodes are arranged as four: a first electrode, a second electrode, a third electrode, and a fourth electrode respectively; the first electrode and the second electrode are arranged at both ends of the P-type doped region, the third electrode and the fourth electrode are arranged at both ends of the N-type doped region; the electrical input terminals are arranged as three: a first electrical input terminal, a second electrical input terminal and a third electrical input terminal respectively; the electrical output terminal is arranged as one; the first electrical input terminal is connected to the first electrode, the second electrical input terminal is connected to the second electrode, the third electrical input terminal is connected to the third electrode, and the electrical output terminal is connected to the fourth electrode; and the electrical signal adjusting circuit is configured to adjust the magnitude of the electrical signal being input, until a voltage input by the first electrical input terminal is greater than a voltage input by the second electrical input terminal, and the voltage input by the second electrical input terminal is as same as a voltage input by the third electrical input terminal.

6. The ion-doped optical waveguide structure according to claim 1, wherein the electrodes is arranged as four: a first electrode, a second electrode, a third electrode, and a fourth electrode respectively; the first electrode and the second electrode are arranged at both ends of the P-type doped region, the third electrode and the fourth electrode are arranged at both ends of the N-type doped region; the electrical input terminals are arranged as three: a first electrical input terminal, a second electrical input terminal and a third electrical input terminal respectively; the electrical output terminal is arranged as one; the first electrical input terminal is connected to the first electrode, the second electrical input terminal is connected to the second electrode, the third electrical input terminal is connected to the third electrode, and the electrical output terminal is connected to the fourth electrode; and the electrical signal adjusting circuit is configured to adjust the magnitude of the electrical signal being input, until a voltage input by the first electrical input terminal is greater than a voltage input by the second electrical input terminal, and the voltage input by the second electrical input terminal is greater than a voltage input by the third electrical input terminal.

7. The ion-doped optical waveguide structure according to claim 1, wherein the electrodes are arranged as three: a first electrode, a second electrode and a third electrode respectively; the first electrode and the second electrode are arranged at both ends of the P-type doped region, and the third electrode is arranged in a middle of the N-type doped region; the electrical input terminals are arranged as two: a first electrical input terminal and a second electrical input terminal respectively; the electrical output terminal is arranged as one; the first electrical input terminal is connected to the first electrode, the second electrical input terminal is connected to the second electrode, and the electrical output terminal is connected to the third electrode; and the electrical signal adjusting circuit is configured to adjust the magnitude of the electrical signal being input, until a voltage input by the first electrical input terminal is greater than a voltage input by the second electrical input terminal.

8. The ion-doped optical waveguide structure according to claim 1, wherein a material of the optical waveguide comprises bulk silicon, silicon-on-insulator, silicon-on-sapphire, aluminum oxide, indium phosphide, lithium niobate, barium titanate, and a plurality of polymers; the optical waveguide comprises a channel waveguide, a ridge waveguide, a slot waveguide, a diffusion waveguide, and a photonic crystal waveguide; a routing shape of the optical waveguide comprises a linear shape and a curved shape; a working wavelength range of the optical waveguide comprises a visible band, an O-band, an E-band, an S-band, a C-band, an L-band, a U-band, and a mid-infrared band; and a plurality of the optical waveguides are arranged in a same layer, or in a plurality of independent layers correspondingly.

9. The ion-doped optical waveguide structure according to claim 1, wherein the P-type doped region and/or the N-type doped region has a same concentration for an impurity doping, or has a plurality of concentrations for different impurity doping.

10. The ion-doped optical waveguide structure according to claim 1, wherein the electrical signal is a fixed voltage or an adjustable voltage; and a relative difference between input voltages at each of the electrical input terminals is adjusted by the electrical signal adjusting circuit.

11. The ion-doped optical waveguide structure according to claim 1, wherein according to a "time division multiplexing" method, the electrical signal adjusting circuit adjusts a voltage applied to the electrodes alternately at different time frames, thus enabling the ion-doped optical waveguide to act as both an optical phase shifter and a variable optical attenuator at a same time.

12. An ion-doped optical waveguide array, comprising:
a plurality of the ion-doped optical waveguides according to claim 1,
wherein the ion-doped optical waveguides are arranged in an order to form an array, and a doping type of the doped regions located on a same side of any adjacent two of the ion-doped optical waveguides is same or opposite.

13. A method of using the ion-doped optical waveguide according to claim 1, comprising:
adjusting the magnitude of the electrical signal applied to the electrodes correspondingly by the electrical signal adjusting circuit, thereby enabling the ion-doped optical waveguide to act as an optical phase shifter and/or a variable optical attenuator.

14. The method according to claim 13, wherein when the electrodes are arranged as four: a first electrode, a second electrode, a third electrode, and a fourth electrode respectively, the first electrode and the second electrode are arranged at both ends of the P-type doped region, and the third electrode and the fourth electrode are arranged at both ends of the N-type doped region; the electrical input terminals are arranged as two: a first electrical input terminal and a second electrical input terminal respectively; and the electrical output terminals are arranged as two: a first electrical output terminal and a second electrical output terminal respectively; and
the method further comprises:
connecting the first electrical input terminal to the first electrode, the second electrical input terminal to the third electrode, the first electrical output terminal to the second electrode, and the second electrical output terminal to the fourth electrode; and
adjusting the magnitude of the electrical signal being input by the electrical signal adjusting circuit, until a voltage input by the first electrical input terminal is as same as or different from a voltage input by the second electrical input terminal, wherein at this time, a current flows through the P-type doped region and the N-type doped region in a direction parallel to the optical waveguide, thereby enabling the ion-doped optical waveguide to act as an optical phase shifter.

15. The method according to claim 13, wherein when the electrodes are arranged as four: a first electrode, a second electrode, a third electrode, and a fourth electrode respectively; the first electrode and the second electrode are arranged at both ends of the P-type doped region, and the third electrode and the fourth electrode are arranged at both ends of the N-type doped region; the electrical input terminals are arranged as two: a first electrical input terminal and a second electrical input terminal respectively; and the electrical output terminals are arranged as two: a first electrical output terminal and a second electrical output terminal respectively; and
the method further comprises:
connecting the first electrical input terminal to the first electrode, the second electrical input terminal to the second electrode, the first electrical output terminal to the third electrode, and the second electrical output terminal to the fourth electrode; and
adjusting the magnitude of the electrical signal being input by the electrical signal adjusting circuit, until a voltage input by the first electrical input terminal is as same as a voltage input by the second electrical input terminal, wherein at this time, a current crosses the optical waveguide in a direction perpendicular to the optical waveguide, that is, flows between the P-type doped region and the N-type doped region, thereby enabling the ion-doped optical waveguide to act as a variable optical attenuator.

16. The method according to claim 13, wherein when the electrodes are arranged as four: a first electrode, a second electrode, a third electrode, and a fourth electrode respectively; the first electrode and the second electrode are arranged at both ends of the P-type doped region, and the third electrode and the fourth electrode are arranged at both ends of the N-type doped region; the electrical input terminals are arranged as two: a first electrical input terminal and a second electrical input terminal respectively; and the electrical output terminals are arranged as two: a first electrical output terminal and a second electrical output terminal respectively; and
the method further comprises:
connecting the first electrical input terminal to the first electrode, the second electrical input terminal to the second electrode, the first electrical output terminal to the third electrode, and the second electrical output terminal to the fourth electrode; and
adjusting the magnitude of the electrical signal being input by the electrical signal adjusting circuit, until a voltage input by the first electrical input terminal is greater than a voltage input by the second electrical input terminal, wherein at this time, a current flows through the P-type doped region in a direction parallel to the optical waveguide, while at a same time, the current crosses the optical waveguide in a direction perpendicular to the optical waveguide and flows from the P-type doped region to the N-type doped region, thereby enabling the ion-doped optical waveguide to act as both an optical phase shifter and a variable optical attenuator at a same time.

17. The method according to claim 13, wherein when the electrodes are arranged as four: a first electrode, a second electrode, a third electrode, and a fourth electrode respectively, the first electrode and the second electrode are arranged at both ends of the P-type doped region, and the third electrode and the fourth electrode are arranged at both ends of the N-type doped region; the electrical input terminals are arranged as three: a first electrical input terminal, a second electrical input terminal and a third electrical input terminal respectively; and the electrical output terminal is arranged as one; and
the method further comprises:
connecting the first electrical input terminal to the first electrode, the second electrical input terminal to the second electrode, the third electrical input terminal to the third electrode, and the electrical output terminal to the fourth electrode; and
adjusting the magnitude of the electrical signal being input by the electrical signal adjusting circuit, until a voltage input by the first electrical input terminal is greater than a voltage input by the second electrical input terminal, and the voltage input by the second electrical input terminal is as same as a voltage input by the third electrical input terminal, wherein at this time, a current flows through the P-type doped region and the N-type doped region in a direction parallel to the optical waveguide, while at a same time, the current crosses the optical waveguide in a perpendicular direction and flows from the P-type doped region to the N-type doped region, thereby enabling the ion-doped optical waveguide to act as both an optical phase shifter and a variable optical attenuator at a same time.

18. The method according to claim 13, wherein when the electrodes are arranged as four: a first electrode, a second electrode, a third electrode, and a fourth electrode respectively; the first electrode and the second electrode are arranged at both ends of the P-type doped region, and the third electrode and the fourth electrode are arranged at both ends of the N-type doped region; the electrical input terminals are arranged as three: a first electrical input terminal, a second electrical input terminal and a third electrical input terminal respectively; and the electrical output terminal is arranged as one; and
the method further comprises:
connecting the first electrical input terminal to the first electrode, the second electrical input terminal to the second electrode, the third electrical input terminal to the third electrode, and the electrical output terminal to the fourth electrode; and
adjusting the magnitude of the electrical signal input by the electrical signal adjusting circuit, until a voltage input by the first electrical input terminal is greater than a voltage input by the second electrical input terminal, and the voltage input by the second electrical input terminal is greater than a voltage input by the third electrical input terminal, wherein at this time, a current flows through the P-type doped region and the N-type doped region in a direction parallel to the optical waveguide, while at a same time, the current crosses the optical waveguide in a perpendicular direction and flows from the P-type doped region to the N-type doped region, thereby enabling the ion-doped optical waveguide to act as an optical phase shifter and a variable optical attenuator at a same time.

19. The method according to claim 13, wherein when the electrodes are arranged as three: a first electrode, a second electrode and a third electrode respectively; the first electrode and the second electrode are arranged at both ends of the P-type doped region, and the third electrode is arranged in a middle of the N-type doped region; the electrical input terminals are arranged as two: a first electrical input terminal and a second electrical input terminal respectively; and the electrical output terminal is arranged as one; and
the method further comprises:
connecting the first electrical input terminal to the first electrode, the second electrical input terminal to the second electrode, and the electrical output terminal to the third electrode; and
adjusting the magnitude of the input electrical signal by the electrical signal adjusting circuit, until a voltage input by the first electrical input terminal is greater than a voltage input by the second electrical input terminal, wherein at this time, a current flows through the P-type doped region in a direction parallel to the optical waveguide, while at a same time, the current crosses the optical waveguide in a direction perpendicular to the optical waveguide and flows from the P-type doped region to the N-type doped region, thereby enabling the ion-doped optical waveguide to act as an optical phase shifter and a variable optical attenuator at a same time.
